(19) United States
(12) Patent Application Publication
(10) Pub. No.: US 2009/0014476 A1
(43) Pub. Date: Jan. 15, 2009

(54) DISPENSER FOR LIQUID

(76) Inventor: Eran Messalem, Tel Aviv (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 12/159,519

(22) PCT Filed: Dec. 28, 2006
(86) PCT No.: PCT/IL2006/001509

§ 371 Date: Aug. 27, 2008

(30) Foreign Application Priority Data
Dec. 29, 2005 (IL) 172897

(51) Int. Cl. B65D 83/00; B29B 7/00; B65D 6/02

(52) U.S. Cl. 222/394; 264/328.1; 220/660

(57) ABSTRACT

The invention is a dispenser for a liquid. The dispenser comprises a container containing the liquid and a pump affixed to the container for moving the liquid from the inside to the outside of the container. The dispenser is characterized by the three dimensional shape of the container in which the relationship between the surface area of its base to its height is such that, the dispenser will not move or topple over when the pump is actuated. An additional characterizing feature is a portion of the surface area of the container, which is located below the outlet of the pump. This portion is shaped such that a receiving means for the liquid can be placed upon the portion and will remain in position when the pump is actuated to dispense the liquid onto its surface. These characterizing features allow the liquid to be dispensed using one hand only providing a dispenser for liquid which combines the features of simplicity, ease, and low cost of manufacture with efficiency and ease of operation, sterility, and accurate provision of the liquid with no spillage or wastage.

### FIELD OF THE INVENTION

The present invention relates to the field of handling liquids. In particular the invention relates to the field of providing a device for dispensing a quantity of liquid from a liquid reservoir onto a receiving means.

### BACKGROUND OF THE INVENTION

The necessity of washing dishes is familiar to everyone and therefore provides a convenient illustrative example of the present invention. To wash dishes by hand in a typical household situation, liquid detergent is supplied in concentrated form in a container. A small amount of the detergent is transferred from the container onto a damp cloth or sponge, which is then rubbed over the surface of the dirty dishes to clean and disinfect them.

There are many different styles of containers for the liquid detergent available in the marketplace. The most basic container is a tall plastic or glass bottle having a cap at its upper end which is either removed or opened to allow the contents to be poured out. Such a dispenser is not convenient as it is difficult to control the amount of liquid that is poured out, often the liquid spills resulting in both economic loss and a “mess” that has to be cleaned up. Additionally both hands are necessary to open the bottle and to hold the bottle and sponge when pouring out the detergent. Since in the course of washing the dishes, detergent has to be frequently added to the sponge, the entire process of picking up the bottle and sponge, putting down the bottle and picking up a dirty dish in order to clean it is very inefficient and time consuming.

To overcome some of these problems, a container in the form of a rectangular open topped box is frequently used. Inside the box is located a flat plate, usually provided with drainage holes. The plate has springs attached to its bottom surface. The springs support it so that it is normally located at the top of the box parallel to the bottom and allow the plate to be pushed downward. A quantity of concentrated detergent is poured into the box, which is then filled to near the top with water. The plate is then put into the box and a sponge is placed on it. Whenever dishes are to be cleaned, the sponge is pressed into the container in order to absorb the liquid which is used to clean the dishes. Because the box is opened and the dirty sponge is frequently returned to it and dipped into the liquid inside the liquid in the box rapidly becomes dirty. If the dirty liquid is allowed to stand between meals, a rapid build-up of bacteria takes place. Thus the box must be frequently cleaned, which often means that the detergent remaining inside is thrown away. Additionally working with the box is messy because the liquid frequently overflows the sides of the box when the sponge is pushed down.

Another solution, which at least partially addresses the issue of wasting the detergent, is to provide the bottle containing the detergent with a dispensing means such as a pump to dispense small quantities of the liquid inside the container in a controlled manner. Most bottles that provide such a solution require the use of both hands, one for pushing the pump and the other to hold a sponge for cleaning the dishes or to support the bottle so that the detergent exiting the pump will be directed onto the sponge.

U.S. Pat. No. 5,507,414 is typical of the inventions that claim to overcome some of the above mentioned difficulties. This patent claims an apparatus for dispensing liquid detergent comprising a base with means for supporting a liquid detergent container above the base. The liquid detergent container has a dispensing orifice located at an elevated level above the base. A concave, upwardly facing liquid detergent receptacle is located atop the base and directly beneath the dispensing orifice. The apparatus also comprises a sponge support hinged relative to the base that can be rotated about a horizontal axis between a lowered horizontal disposition located directly above the liquid detergent receptacle and a raised disposition out of vertical alignment with the dispensing orifice and the liquid detergent receptacle. A tubular brush support projecting upwardly from the base, a brush having an elongated handle that can be inserted into and removed from the brush support, and a soap bar tray located atop the base are also provided.

Other designs of devices for dispensing liquids are described in, for example, U.S. design Pat. D530,953, and U.S. utility Pat. 6,419,123, U.S. Pat. No. 4,640,483, and U.S. Pat. No. 5,678,733.

None of the above publications provide a solution to the problem of dispensing liquids, such as liquid detergent, that combine the features of simplicity and ease of manufacture, sterility, accurate provision of the liquid with no spillage or wastage, one hand operation made possible by the stability of the device and provision of an outer surface of the container which serves as a base onto which the means to which the liquid inside is dispensed.

It is therefore a purpose of the present invention to provide a dispenser for liquid which overcomes the above drawbacks of the prior art.

It is another purpose of the present invention to provide a dispenser for liquid which comprises, in a single unit, the features of simplicity and ease of manufacture, sterility, accurate provision of the liquid with no spillage or wastage, one hand operation made possible by the stability of the device and provision of an outer surface of the container which serves as a base onto which the means to which the liquid inside is dispensed.

Further purposes and advantages of this invention will appear as the description proceeds.

### SUMMARY OF THE INVENTION

The invention is a dispenser for a liquid. The dispenser comprises a container containing the liquid and a pump affixed to the container for moving the liquid from the inside to the outside of the container. The dispenser is characterized by three dimensional shape the container in which the relationship between the surface area of its base to its height is such that, the dispenser will not move or topple over when the pump is actuated. An additional characterizing feature is a portion of the surface area of the container, which is located below the outlet of the pump. This portion is shaped such that a receiving means for the liquid can be placed upon the portion and will remain in position when the pump is actuated to dispense the liquid onto its surface. These characterizing features allow the liquid to be dispensed using one hand only.

The pump of the dispenser of the invention can be actuated either manually, hydraulically, pneumatically, or electrically.

The receiving means can be selected from the group comprising: a pad, a sponge, a rag, a cloth, a brush, and a disposable or reusable cup and the liquid can be selected from the group comprising: liquid per se, a gel, a cream, a paste, or a solution containing a chemical dispersed in a liquid per se, a gel, a cream, or a paste.

The surface of the container of the dispenser of the invention is designed to cause liquid to drain off the dispenser. The portion of the surface on which the receiving means is placed may comprise grooves to aid in channeling the water off the dispenser or projections, which allow excess water to drain out of the receiving means.

The dispenser can be manufactured from one or more materials selected from the group comprising: pp, pet, Polycarbonate, Polyethylene, pvc, ceramic material, glass, metal, stainless steel, wood, silicon, Teflon, and biocompatible materials.

All the above and other characteristics and advantages of the invention will be further understood through the following illustrative and non-limitative description of preferred embodiments thereof, with reference to the appended drawings.

### BRIEF DESCRIPTION OF THE DRAWINGS

FIG. 1A shows a perspective view of a first embodiment of the dispenser of the present invention;

FIG. 1B shows a side view of the dispenser of FIG. 1A;

FIG. 1C shows a top view of the dispenser of FIG. 1A;

FIG. 1D shows a front view of the dispenser of FIG. 1A;

FIG. 1E shows a cross section A-A of the dispenser of FIG. 1D;

FIG. 2A shows a perspective view of the dispenser of FIG. 1A having a sponge;

FIG. 2B shows a side view of the dispenser of FIG. 1B having a sponge;

FIG. 3A shows a perspective view of another embodiment of the dispenser of the present invention;

FIG. 3B shows a side view of the dispenser of FIG. 3A;

FIG. 3C shows a top view of the dispenser of FIG. 3A;

FIG. 4A shows a perspective view of the dispenser of FIG. 3A having a sponge;

FIG. 4B shows a side view of the dispenser of FIG. 3B having a sponge;

FIG. 5A shows a perspective view of another embodiment of the dispenser of the present invention;

FIG. 5B shows a side view of the dispenser of FIG. 5A;

FIG. 5C shows a top view of the dispenser of FIG. 5A;

FIG. 5D shows a front view of the dispenser of FIG. 5A; and

FIG. 6 shows one example of an embodiment of a pump which may be used as actuating means in the present invention.

### DETAILED DESCRIPTION OF PREFERRED EMBODIMENTS

As used herein the term “liquid” refers to a liquid per se such as water or any material having the properties of a liquid, e.g., a gel, a cream, a paste or a solution comprised of a chemical dispersed in a liquid per se a gel, a cream, or a paste.

As used herein the term “receiving means” refers to an object, e.g. a pad, a sponge, a rag, a cloth, or a brush, onto which the liquid is dispensed. The receiving means can also be a disposable or reusable cup.

As used herein the term “pump” may be any suitable means, that can be attached to the container and by means of which the liquid can be transferred from inside the container to the receiving means, e.g. a manually, hydraulically, pneumatically, or electrically operated pump, a diaphragm, valve, tap, or lever.

The present invention is a dispenser for a liquid. The dispenser comprises of a container to which is affixed a pump for moving the liquid from the inside of the container to the outside. The container is characterized by its shape, which is designed specifically to provide two functions: firstly stability and secondly a portion of the surface area, located below the outlet of the pump, is shaped such that a receiving means for the liquid can be placed upon it. If these two features of the shape of the container are provided then when a receiving means, such as a pad or sponge, is placed on the designated portion of the surface and the pump is actuated to pump liquid from the container onto the receiving means, it is not necessary to hold either the dispenser or the receiving means and therefore the liquid can be dispensed using one hand only.

The pump may be connected to the container by any suitable connecting means such as a hole located in the container through which the actuating means may be inserted by screwing, welding, pasting, a friction fit, snap, etc.

The container of the present invention may have any suitable overall form, e.g. oval, spherical, cubic, polyhedron, or a combination thereof. The only requirements being that the bottom, i.e. the surface area of the container that is in contact with the object on which the container rests, e.g. a countertop, a flat horizontal wall of a sink, is matched to the surface on which it rests and is sufficiently large with respect to the height of the dispenser such that the dispenser will not move or topple over when the pump is actuated, i.e. the stability characteristic of the dispenser must be present.

The portion of the surface on which the receiving means is placed may have a different shape than the overall shape of the container. This portion of the surface of the container may be, for example horizontal, sloping, concave, convex, or a combination thereof, provided that the receiving means will not fall when placed on it. The surface of the container on which the receiving means are located may be smooth or coarse and/or may have projections, ridges or grooves on it. The existence of a portion of the surface on which the receiving means can rest without being held provides a significant advantage in simplicity and ease of use over prior art liquid dispensers, which dispense the liquid onto receiving means that must be held in one of the user's hands, while the liquid is dispensed using the other hand.

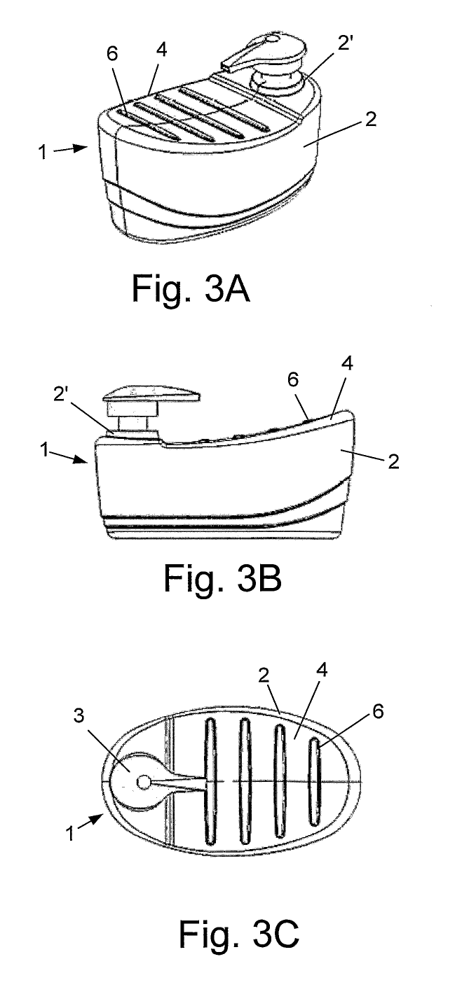

A significant characteristic of the dispenser of the invention is the level of sterility, cleanliness, and economy it provides. The container is closed, therefore the liquid inside remains clean and sterile; the stability prevents accidental spilling; and the liquid is dispensed in uniform doses directly onto the receiving means, thereby preventing wastage of the liquid. If the portion of the surface of the container that supports the receiving means comprises projections such as the ridges shown in FIGS. 3a to 3c then, each time the receive means is placed on the surface, the excess liquid in it will be able to freely drain away. The entire surface of the container can be designed to aid this process including the addition of grooves to drain the water off. In particular, after washing the dishes, the receiving means can be rinsed and returned to the surface where it will air dry without the danger of creating pools of water or closed damp places that are ideal breeding grounds for bacteria and unpleasant odors.

The container and/or the pump of the present invention may be entirely or partially manufactured from any suitable plastic material e.g. pp, pet, Polycarbonate, Polyethylene, pvc. Non-plastic materials such as various ceramics, glass, metal (advantageously stainless steel), silicon, Teflon and its derivatives, wood coated with a suitable, liquid-proof material such as varnish, lacquer, or plastic, and biocompatible materials suitable for pharmaceuticals solutions.

The container of the dispenser device can be made by any one of many different known commercial production techniques. In order to provide the most economical product, the preferred manufacturing method is blow molding in which a plastic tube is placed into a mold and heated and expanded by air blow into it causing it to expand until it is pushed against the inside walls of the mold. When cooled and released from the mold, the result is a hollow one-piece vessel that has uniform wall thickness and the shape of the mold. Other one-step manufacturing processes that can be used are rotational molding for plastics and ceramic molding for ceramic material. Other more complex manufacturing process, such as injection molding can also be used, but they are more expensive and will increase the final cost of the dispenser to the consumer.

It is to be emphasized that the liquid that is being dispensed will most likely be a consumer product for which the price is one of the main features noted by the buyer when measuring the product against similar products. Therefore the fact that at least the container of the dispenser of the invention can be produced in large quantities very cheaply by a one-step process such as blow molding, gives the invention an important competitive edge.

The dispenser in accordance with the present invention may be for a one-time use or multiple uses. The dispenser of the invention is designed to be a free-standing device, but it is apparent that means can be provided for hanging it from, for example a wall.

Embodiments of the invention will now be described in connection with dish washing liquid. However, the dispenser of the invention is not restricted to this use and can be used for other purposes, such as dispensing liquid hand or bath soaps, cosmetic or pharmaceutical products such as body lotion, skin creams, or fingernail polish remover. The dispenser can be used to dispense liquids such as furniture, shoe, or car polish; in industry to dispense paste for use in electrical circuit production or welding; or in a clinical or laboratory environment to apply ointments, etc. to sterile pads. Although the example of a receiving means used herein is a sponge or pad, other objects can be used as previously mentioned. In particular, in some applications it might be desired to dispense a liquid such as a face cream or a medicine for topical application directly into a disposable cup, which can be taken to a location remote from the dispenser for use.

In the figures are shown three different embodiments of the container of the liquid dispenser of the invention. In the figures like numerals are used to identify like features of the dispenser.

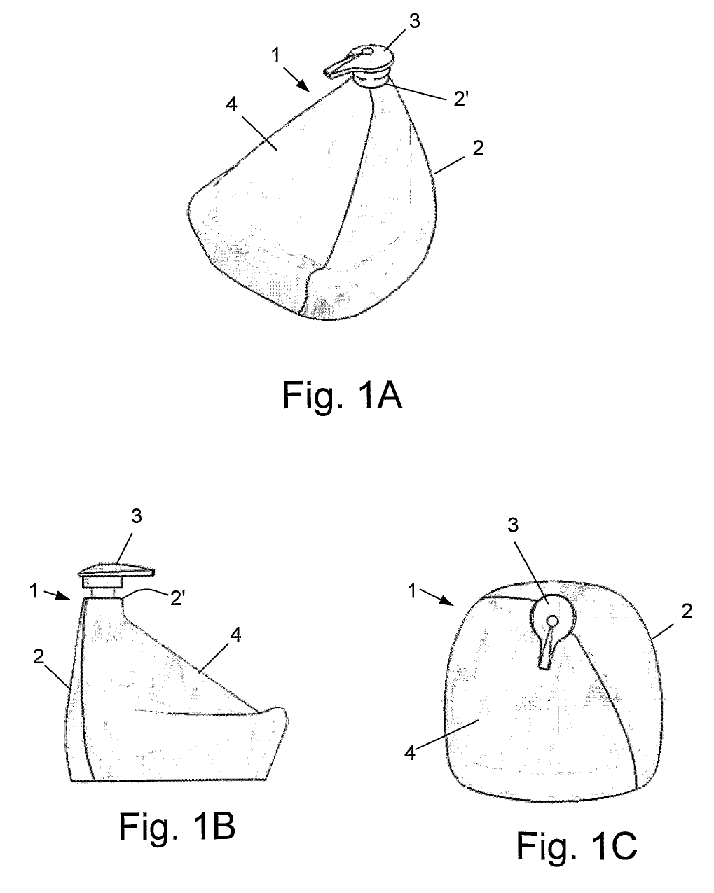

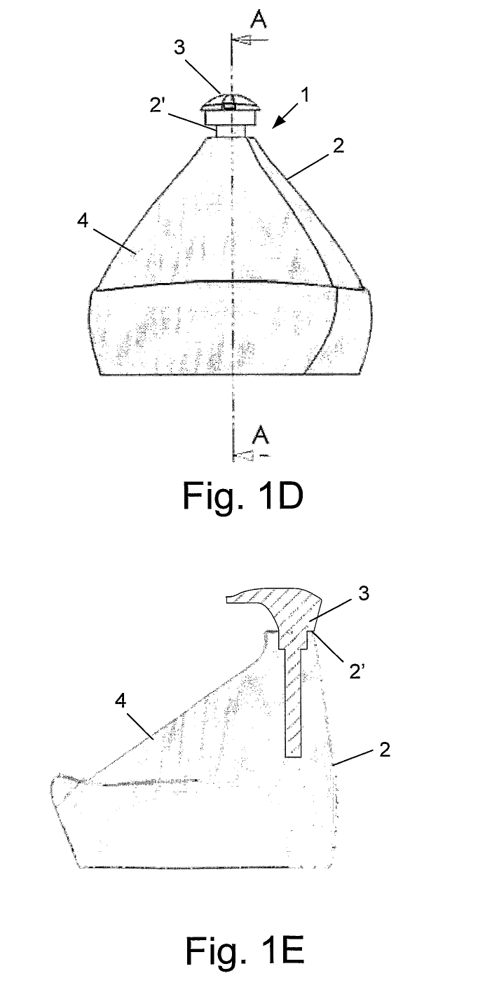

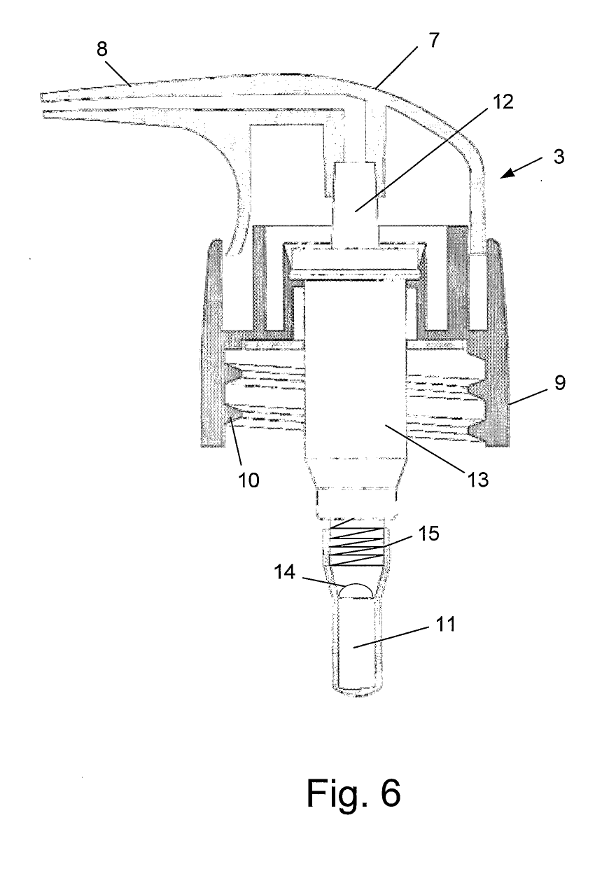

A first embodiment of the liquid dispenser of the invention is shown in perspective, side, top, and front views in FIGS. 1A to 1D respectively. FIG. 1E is a cross-sectional view taken along plane A-A in FIG. 1D. Dispenser 1 is comprised of container 2 and pump 3. Pump 3 will be described herein below with respect to FIG. 6. It is attached to container 2 at opening 2′ in the top of the container. Opening 2′ can be in the form of a neck that projects above the container or flush with the top of the container as shown in FIG. 1E. The inside of the opening can be threaded to match threads on the pump (see FIG. 6) making it easy to attach and detach the pump to/from the container. In this case the container can easily be refilled with liquid when necessary. Other methods of attaching the pump to the container are possible, for example, if the inside of opening 2′ is smooth and tapered and the pump comprises a matching tapered surface, the pump can be pushed into the opening and will be held there by friction. If dispenser 1 is sold as a single use consumer item, then pump 3 can be glued, welded, etc. into opening 2′ after container 2 has been filled with liquid.

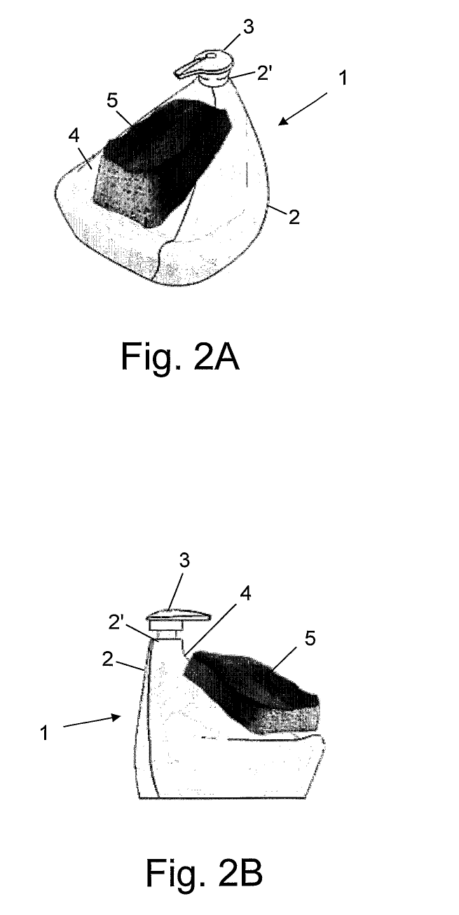

In this embodiment, container 2 has very roughly an overall cubical shape with its height less than its length and width to provide increased stability. A portion of the “cube” has been removed to leave an inclined planar portion of the surface 4 on which the receiving means is to be placed. FIGS. 2A and 2B are perspective and side views of this embodiment of the dispenser 1 showing the receiving means 5, in this case a sponge, in place on the portion of the surface 4.

The use of the dispenser of the invention is clear from the figures. After receiving means 5 is placed on the portion 4 of the surface of container 2, the pump is actuated, for example by pushing down on it one or more times, to cause the desired amount of liquid to be pumped out of the container onto the receiving means. Referring to the example of washing dishes, the entire operation comprising: positioning the receiving means, activating the pump, and picking up the receiving means, and using it to wipe clean the surfaces of the dishes, can be accomplished with one hand only, while the other hand is free to carry out other tasks, such as rinsing the detergent off the cleaned dish, transferring a rinsed dish to a drainage rack, etc.

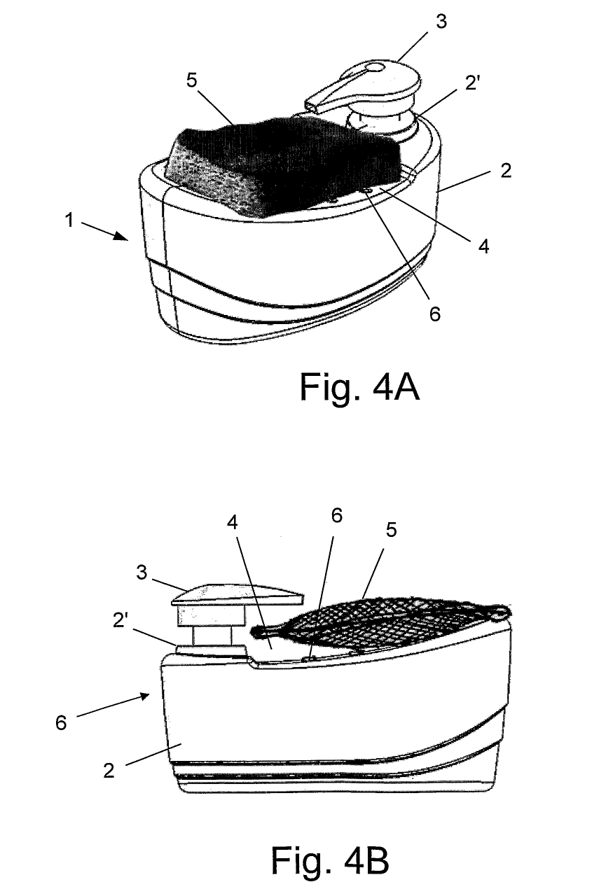

A second embodiment of the liquid dispenser 1 of the invention is shown in perspective, side, and top views in FIGS. 3A, 3B, and 3C respectively and with the receiving means 5 in place in FIGS. 4A and 4B. In this embodiment, container 2 is boat-shaped and the portion of its surface 4 on which the receiving means is to be placed has a slightly concave shape. Projections 6, in the form of a number of parallel ridges, are provided on the portion of the surface 4 to allow excess moisture to drain away from receiving means 5.

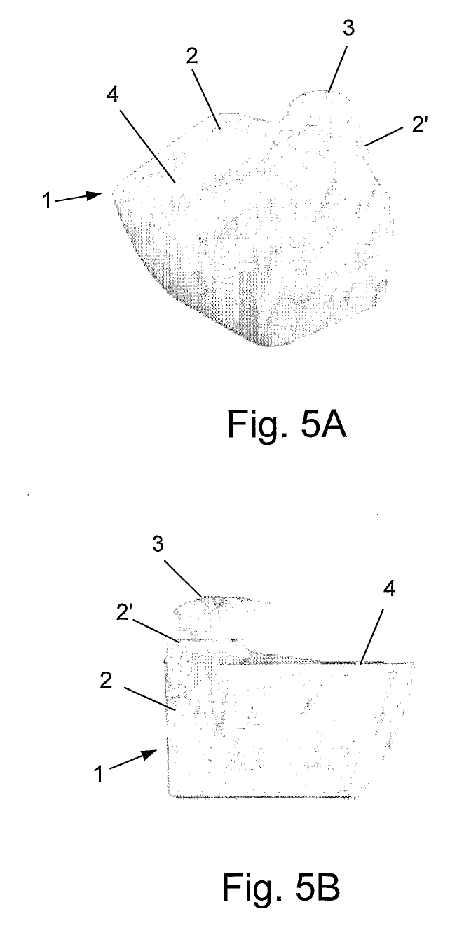

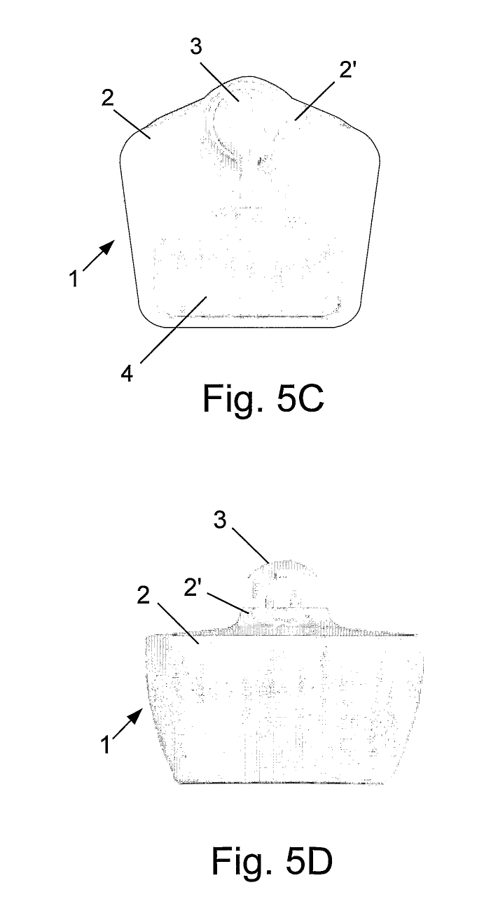

A third embodiment of the liquid dispenser of the invention is shown in perspective, side, top, and front views in FIGS. 5A to 5D respectively. In this embodiment the portion of the surface 4 is a horizontal planar surface at the bottom of a shallow well that has roughly the shape of the receiving means 5.

FIG. 6 is one embodiment of the pump 3 used with the liquid dispenser 1 of the invention. The pump is attached to the container by means of cap 9 which can be rotated to engage external thread 10 with a mating internal thread on the container. At the top is a handle 7, which comprises an integrated nozzle 8. Pushing downwards on the handle forces plunger 12 down into chamber 13. As a result, liquid within chamber 13 is forced out through nozzle 8. When the downward force on handle 7 is removed, spring 15 forces plunger 12 upwards allowing liquid from the container to be sucked up through tube 11 past one-way valve 14 into chamber 13; thereby reading the dispenser for the next downstroke.

Although embodiments of the invention have been described by way of illustration, it will be understood that the invention may be carried out with many variations, modifications, and adaptations, without exceeding the scope of the claims.

1-10. (canceled)

11. A dispenser for a liquid, said dispenser comprising a container adapted to contain said liquid and a pump affixed to said container for moving said liquid from the inside to the outside of said container;
said dispenser characterized by:
said container has a three dimensional shape in which the relationship between the surface area of its base to its height is such that, said dispenser will not move or topple over when said pump is actuated; and
a portion of the surface area of said container, which is located below the outlet of said pump, is shaped to enable a receiving means for said liquid to be placed directly upon said portion, to rest without being held, and to remain in position when said pump is actuated to dispense said liquid onto the surface of said receiving means;
thereby allowing said liquid to be dispensed onto said receiving means using one hand only.

12. A dispenser according to claim 11, wherein the pump is actuated in one of the following ways: manually, hydraulically, pneumatically, or electrically.

13. A dispenser according to claim 11, wherein surface of the container is designed to cause liquid to drain off said dispenser.

14. A dispenser according to claim 13, wherein the portion of the surface on which the receiving means is placed comprises grooves to aid in channeling the water off said dispenser.

15. A dispenser according to claim 13 wherein the portion of the surface on which the receiving means is placed comprises projections, which allow excess water to drain out of said receiving means.

16. A dispenser according to claim 11, wherein said dispenser is manufactured from one or more materials selected from the group comprising: pp, pet, Polycarbonate, Polyethylene, PVC, ceramic material, glass, metal, stainless steel, wood, silicon, Teflon, and biocompatible materials.

17. A method for manufacturing a dispenser according to claim 11, wherein said method is a one-step method chosen from: blow molding, rotational molding, and ceramic molding.

18. A method for manufacturing a dispenser according to claim 11, wherein said method is injection molding.

19. A system for dispensing a liquid onto a receiving means, said system comprising:
a) a dispenser according to claim 11;
b) a receiving means;
c) a quantity of liquid contained within said dispenser.

20. A system according to claim 19, wherein the receiving means are selected from the group comprising: a pad, a sponge, a rag, a cloth, a brush, and a disposable or reusable cup.

21. A system according to claim 19, wherein the liquid is selected from the group comprising: liquid per se, a gel, a cream, a paste, or a solution comprised of a chemical dispersed in a liquid per se, a gel, a cream or a paste.
